(19) United States
(12) Patent Application Publication
(10) Pub. No.: US 2025/0195320 A1
(43) Pub. Date: Jun. 19, 2025

(54) MALE SEXUAL STIMULATION DEVICE

(71) Applicant: Anrui Health Technology (Dongguan) Co., Ltd., Dongguan City (CN)

(72) Inventor: ZHIPING TU, Dongguan City (CN)

(21) Appl. No.: 18/402,449

(22) Filed: Jan. 2, 2024

(30) Foreign Application Priority Data
Dec. 15, 2023 (CN) 202323443302.X

(51) Int. Cl. A61H 19/00; A61H 23/02; H02P 25/03

(52) U.S. Cl. CPC A61H 19/32; A61H 23/0254; H02P 25/03; A61H 2201/0107; A61H 2201/149; A61H 2201/1635; A61H 2201/1669; A61H 2201/5007; A61H 2201/5025

(57) ABSTRACT

The present disclosure provides a male sexual stimulation device. The male sexual stimulation device includes a shell, a brushless motor, a first micro control unit (MCU), a screw rod, a sliding block and a connector. The shell is provided with a first accommodating chamber. The brushless motor is arranged in the first accommodating chamber. The first MCU is arranged in the first accommodating chamber and is electrically connected to the brushless motor. The screw rod is connected to an output end of the brushless motor and rotates in a reciprocating manner under the driving of the brushless motor. The sliding block is in threaded connection to the screw rod and does a reciprocating motion under the driving of the screw rod. The connector is connected to the sliding block and moves in a reciprocating manner with the sliding block; and the connector is configured to connect a flexible sleeve.

### CROSS-REFERENCE TO RELATED APPLICATIONS

The application claims priority of Chinese patent application CN202323443302X, filed on Dec. 15, 2023, which is incorporated herein by reference in its entireties.

### TECHNICAL FIELD

The present disclosure relates to the technical field of adult health products for men, and in particular, to a male sexual stimulation device.

### BACKGROUND

In daily life, as the pace of life speeds up, people's stress increases every day. At the same time, with the diversified development of the social thought, using adult health products to relieve the stress is more and more popular. For example, masturbators offer single adult men or men who have been separated from their spouses for a long time the possibility of releasing some of their stress, and can address their physiological needs. Meanwhile, this also reduces crimes, whoring, and other actions.

At present, the existing masturbators on the market usually have a single function, cannot simulate cases realistically, and cannot play a role in assisting a user in releasing the stress. Movement speeds and strokes of the masturbators are usually fixed, making it difficult to adjust the masturbators, and the user cannot get a good and realistic experience. Moreover, it is inconvenient to hold the masturbators during use, so that the masturbators cannot be adjusted quickly, and the use experience is poor.

For this purpose, the present disclosure provides a male sexual stimulation device that can effectively solve the above problems. The male sexual stimulation device has a simple structure and is convenient to use and adjust.

### SUMMARY

In order to overcome the shortcomings of the prior art, the present disclosure provides a male sexual stimulation device, which has a simple structure and is convenient to use and adjust.

The technical solution adopted by the present disclosure to solve the technical problem is as follows:

A male sexual stimulation device, including:
a shell, wherein the shell is provided with a first accommodating chamber;
a brushless motor, wherein the brushless motor is arranged in the first accommodating chamber;
a first micro control unit (MCU), wherein the first MCU is arranged in the first accommodating chamber and is electrically connected to the brushless motor; the first MCU controls a rotating speed of the brushless motor and/or an initial position and final position of the brushless motor;
a screw rod, wherein the screw rod is connected to an output end of the brushless motor and rotates in a reciprocating manner under the driving of the brushless motor;
a sliding block, wherein the sliding block is in threaded connection to the screw rod and does a reciprocating motion under the driving of the screw rod; and
a connector, wherein the connector is connected to the sliding block and moves in a reciprocating manner with the sliding block; and the connector is configured to connect a flexible sleeve.

As the improvement of the present disclosure, the male sexual stimulation device further includes a sliding rod, wherein the sliding rod is substantially parallel to the screw rod, and the sliding block is provided with a sliding hole; the sliding rod is inserted along the sliding hole; and when the sliding block is in reciprocating motion driven by the screw rod, the sliding hole slides in a reciprocating manner along a surface of the sliding rod.

As the improvement of the present disclosure, the male sexual stimulation device further includes two handles, wherein the two handles protrude out along two sides of the shell, and the handles are provided for being held by a user.

As the improvement of the present disclosure, the male sexual stimulation device further includes adjustment buttons and a second MCU, wherein the handles are provided with a second accommodating chamber and button holes that passes through surfaces of the handles and are communicated to the second accommodating chamber; the second MCU is arranged in the second accommodating chamber; the adjustment buttons are connected to the second MCU and protrude out along the button holes; the second MCU is electrically connected to the first MCU; the second MCU generates a first electrical signal in response to a user operation; and the first MCU receives the first electrical signal and controls the rotating speed of the brushless motor and/or the initial position and final position of the brushless motor according to the first electrical signal.

As the improvement of the present disclosure, the male sexual stimulation device further includes an ON/OFF button and a third MCU, wherein the third MCU is arranged in the second accommodating chamber; the ON/OFF button is connected to the third MCU and protrudes out along the button holes; the third MCU is electrically connected to the first MCU; the third MCU generates a second electrical signal in response to a user operation; and the first MCU receives the second electrical signal and controls, according to the second electrical signal, the brushless motor to be turned on or turned off.

As the improvement of the present disclosure, the male sexual stimulation device further includes a detection unit, wherein the detection unit is electrically connected to the first MCU; the detection unit detects a position of the sliding block and generates a third electrical signal; and the first MCU receives the third electrical signal and controls, according to the third electrical signal, the brushless motor to adjust the initial position and final position of the reciprocating motion.

As the improvement of the present disclosure, the male sexual stimulation device further includes a power supply module, wherein the power supply module is electrically connected to the first MCU and is electrically connected to the second MCU, the third MCU, and the brushless motor through the first MCU.

As the improvement of the present disclosure, the power supply module includes a power interface, a charging circuit, a battery, and a voltage stabilizing circuit; the charging circuit is electrically connected to the power interface and the battery; and the voltage stabilizing circuit is electrically connected to the battery and the first MCU.

As the improvement of the present disclosure, the male sexual stimulation device further includes a state indication unit, wherein the state indication unit is electrically connected to the first MCU.

As the improvement of the present disclosure, the connector includes a connecting rod and a connecting block; a surface of the shell is provided with a sliding chute; an extension direction of the sliding chute is matched with a direction of the screw rod; one end of the connecting rod is connected to the sliding block; and the other end of the connecting rod protrudes out of the sliding chute and is connected to the connecting block.

As the improvement of the present disclosure, the male sexual stimulation device further includes a driving unit. The driving unit is electrically connected to the first MCU and the brushless motor; the first MCU controls the rotating speed of the brushless motor and/or the initial position and final position of the brushless motor through the driving unit.

As the improvement of the present disclosure, the male sexual stimulation device further includes a boosting unit. An input end of the boosting unit is electrically connected to the first MCU, and an output end of the boosting unit is electrically connected to the brushless motor.

As the improvement of the present disclosure, the male sexual stimulation device further includes an input unit. An output end of the input unit is electrically connected to the first MCU, and the input unit is configured to input and/or output information.

The present disclosure also provides a male sexual stimulation device, including:
a shell, wherein the shell is provided with a first accommodating chamber;
a brushless motor, wherein the brushless motor is arranged in the first accommodating chamber;
a first micro control unit (MCU), wherein the first MCU is arranged in the first accommodating chamber and is electrically connected to the brushless motor; the first MCU controls a rotating speed of the brushless motor and/or an initial position and final position of the brushless motor;
a screw rod, wherein the screw rod is connected to an output end of the brushless motor and rotates in a reciprocating manner under the driving of the brushless motor;
a sliding block, wherein the sliding block is in threaded connection to the screw rod and does a reciprocating motion under the driving of the screw rod;
a connector, wherein the connector is connected to the sliding block and moves in a reciprocating manner with the sliding block; and
a flexible sleeve, wherein the flexible sleeve is connected to the connector.

As the improvement of the present disclosure, the male sexual stimulation device further includes a sliding rod, wherein the sliding rod is substantially parallel to the screw rod, and the sliding block is provided with a sliding hole; the sliding rod is inserted along the sliding hole; and when the screw rod is driven to move in the reciprocating manner, the sliding hole slides in a reciprocating manner along a surface of the sliding rod.

As the improvement of the present disclosure, the male sexual stimulation device further includes two handles, wherein the two handles protrude out along two sides of the shell, and the handles are provided for being held by a user.

As the improvement of the present disclosure, the male sexual stimulation device further includes adjustment buttons and a second MCU, wherein the handles are provided with a second accommodating chamber and button holes that passes through surfaces of the handles and are communicated to the second accommodating chamber; the second MCU is arranged in the second accommodating chamber; the adjustment buttons are connected to the second MCU and protrude out along the button holes; the second MCU is electrically connected to the first MCU; the second MCU generates a first electrical signal in response to a user operation; and the first MCU receives the first electrical signal and controls the rotating speed of the brushless motor and/or the initial position and final position of the brushless motor according to the first electrical signal.

As the improvement of the present disclosure, the male sexual stimulation device further includes an ON/OFF button and a third MCU, wherein the third MCU is arranged in the second accommodating chamber; the ON/OFF button is connected to the third MCU and protrudes out along the button holes; the third MCU is electrically connected to the first MCU; the third MCU generates a second electrical signal in response to a user operation; and the first MCU receives the second electrical signal and controls, according to the second electrical signal, the brushless motor to be turned on or turned off.

As the improvement of the present disclosure, the male sexual stimulation device further includes a detection unit, wherein the detection unit is electrically connected to the first MCU; the detection unit detects a position of the sliding block and generates a third electrical signal; and the first MCU receives the third electrical signal and controls, according to the third electrical signal, the brushless motor to adjust the initial position and final position of the reciprocating motion.

As the improvement of the present disclosure, the male sexual stimulation device further includes a power supply module, wherein the power supply module is electrically connected to the first MCU and is electrically connected to the second MCU, the third MCU, and the brushless motor through the first MCU.

As the improvement of the present disclosure, the power supply module includes a power interface, a charging circuit, a battery, and a voltage stabilizing circuit; the charging circuit is electrically connected to the power interface and the battery; and the voltage stabilizing circuit is electrically connected to the battery and the first MCU.

As the improvement of the present disclosure, the male sexual stimulation device further includes a state indication unit, wherein the state indication unit is electrically connected to the first MCU.

As the improvement of the present disclosure, the connector includes a connecting rod and a connecting block; a surface of the shell is provided with a sliding chute; an extension direction of the sliding chute is matched with a direction of the screw rod; one end of the connecting rod is connected to the sliding block; and the other end of the connecting rod protrudes out of the sliding chute and is connected to the connecting block.

As the improvement of the present disclosure, the male sexual stimulation device further includes a driving unit. The driving unit is electrically connected to the first MCU and the brushless motor; the first MCU controls the rotating speed of the brushless motor and/or the initial position and final position of the brushless motor through the driving unit.

As the improvement of the present disclosure, the male sexual stimulation device further includes a boosting unit. An input end of the boosting unit is electrically connected to the first MCU, and an output end of the boosting unit is electrically connected to the brushless motor.

As the improvement of the present disclosure, the male sexual stimulation device further includes an input unit. An output end of the input unit is electrically connected to the first MCU, and the input unit is configured to input and/or output information.

Beneficial effects of the present disclosure are as follows: during use, the first MCU controls the brushless motor to do the reciprocating motion, and the screw rod rotates in the reciprocating manner with the brushless motor. The sliding block is in threaded connection to the screw rod. When the screw rod rotates in the reciprocating manner, the sliding block is driven to do a linear reciprocating motion, thereby driving the connector and the flexible sleeve connected to the connector, which can rub and stimulate a male genital organ put into the flexible sleeve and provide a user with sexual stimulation. It is convenient to use. Meanwhile, the user can also control the rotating speed of the brushless motor and/or the initial position and final position of the brushless motor through the first MCU, thereby controlling speeds and strokes of the reciprocating motions of both the connector and the flexible sleeve connected to the connector, so that the user can freely adjust the product according to own needs, and the applicability of the product is improved.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of a first perspective structure according to the present disclosure;

FIG. 2 is a schematic diagram of a second perspective structure according to the present disclosure, wherein a connector is in an initial position;

FIG. 3 is a schematic diagram of a third perspective structure according to the present disclosure, wherein a connector is in a final position;

FIG. 4 is a schematic diagram of a fourth perspective structure according to the present disclosure, wherein a connector is connected with a flexible sleeve;

FIG. 5 is a schematic diagram of a first exploded structure according to the present disclosure;

FIG. 6 is a schematic diagram of a second exploded structure according to the present disclosure;

FIG. 7 is a first sectional view according to the present disclosure, wherein a connector is in an initial position;

FIG. 8 is a second sectional view according to the present disclosure, wherein a connector is in a final position;

FIG. 9 is a partial view of the present disclosure;

FIG. 10 is a circuit block diagram of the present disclosure;

FIG. 11 is a circuit block diagram of a power supply module according to the present disclosure;

FIG. 12 is a first partial circuit diagram of the present disclosure; and

FIG. 13 is a second partial circuit diagram of the present disclosure.

### DETAILED DESCRIPTION OF THE EMBODIMENTS

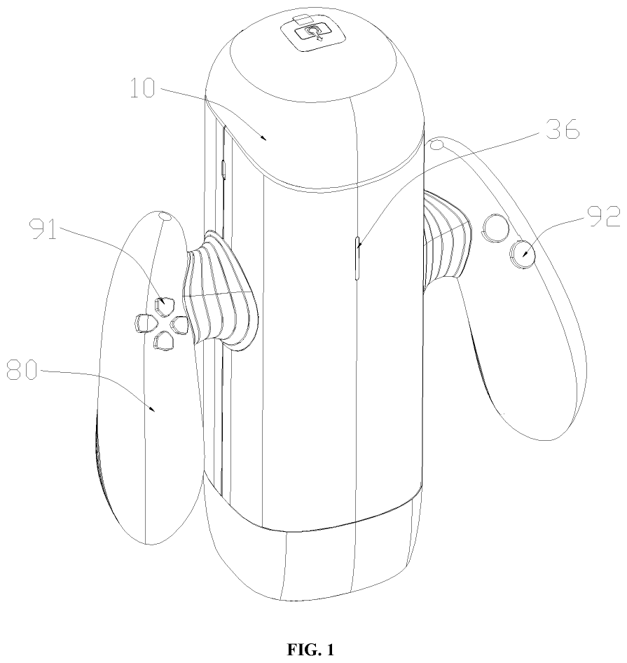

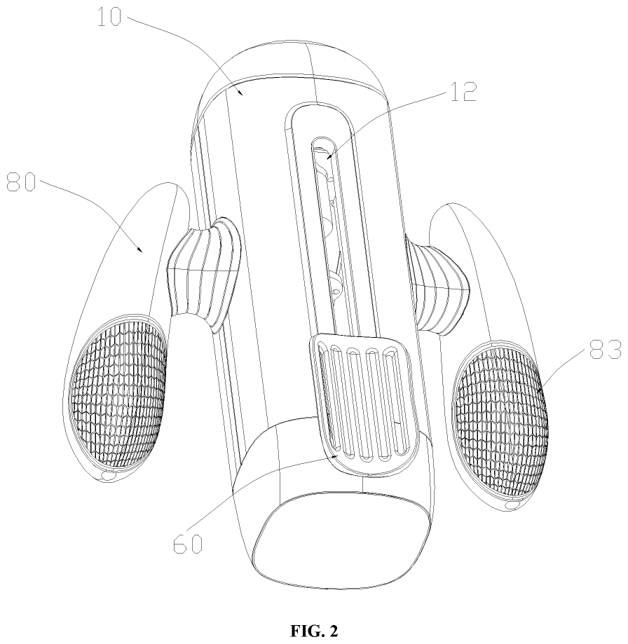

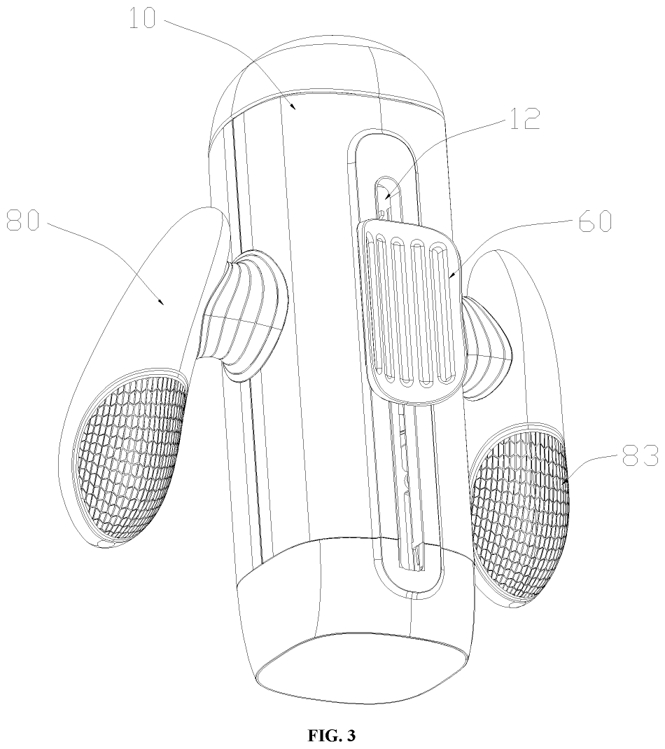

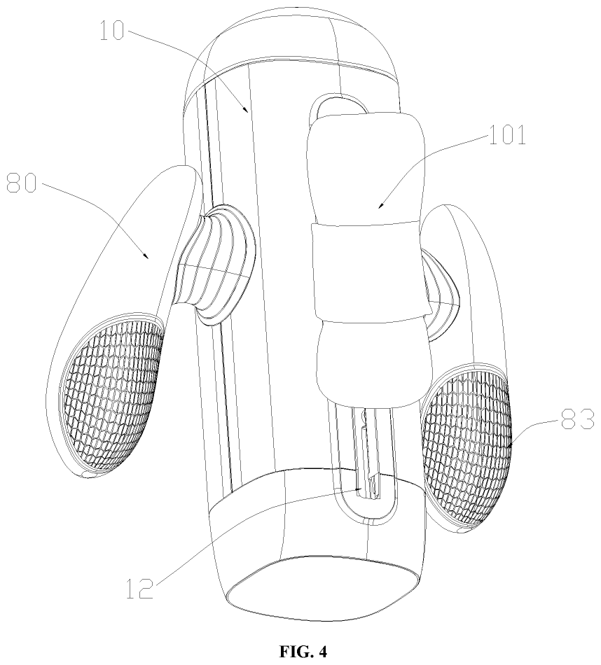

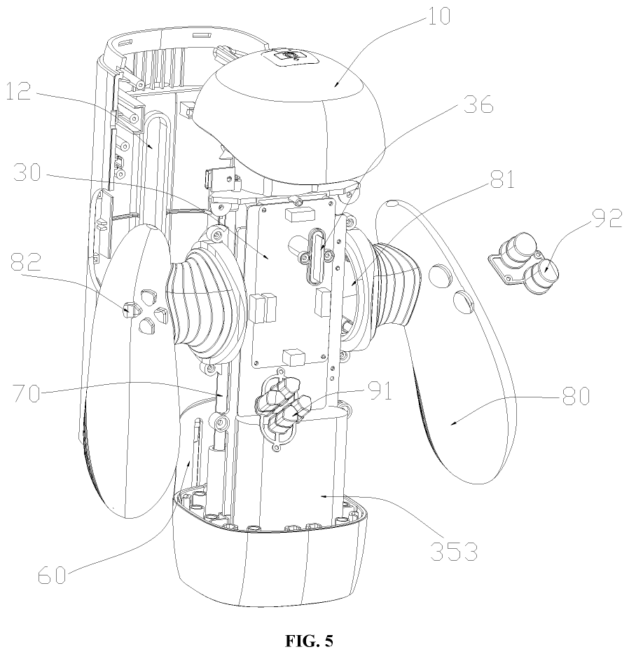

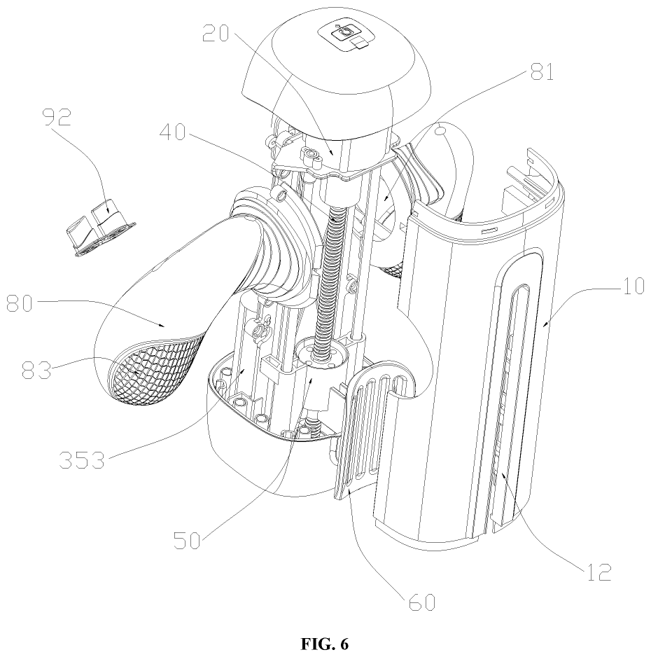

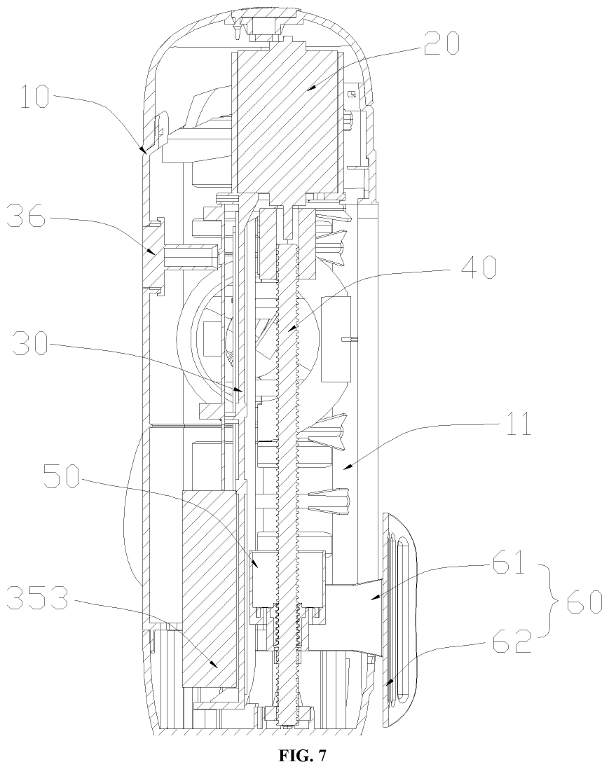

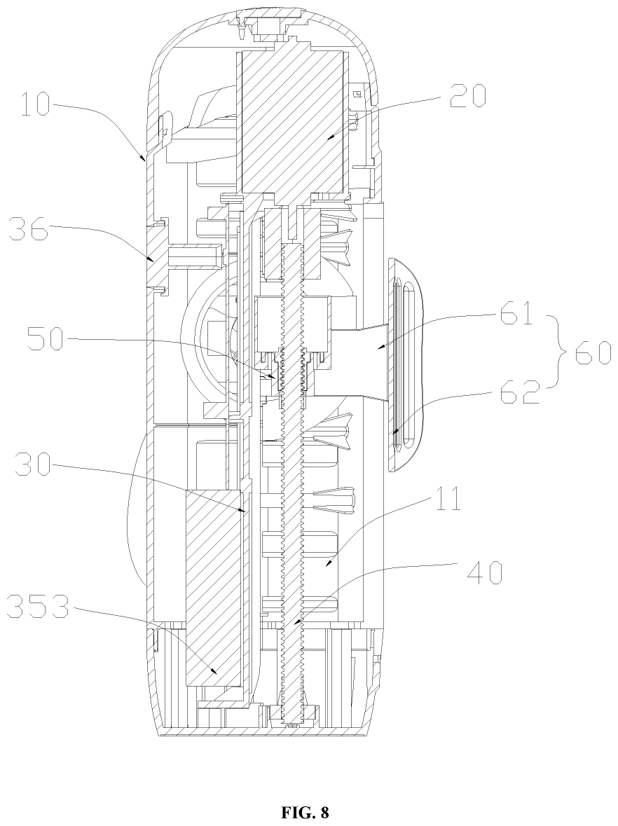

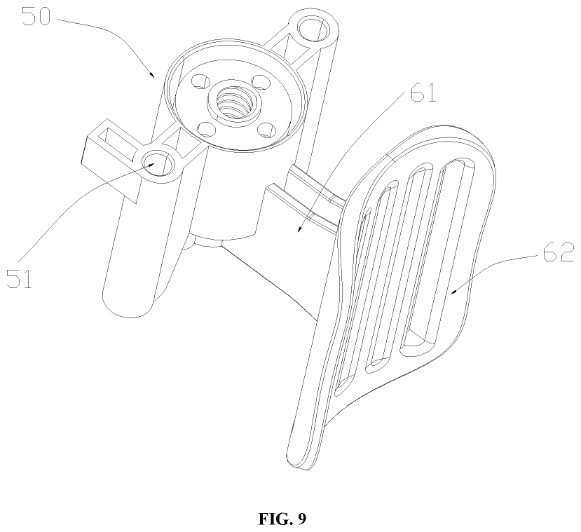

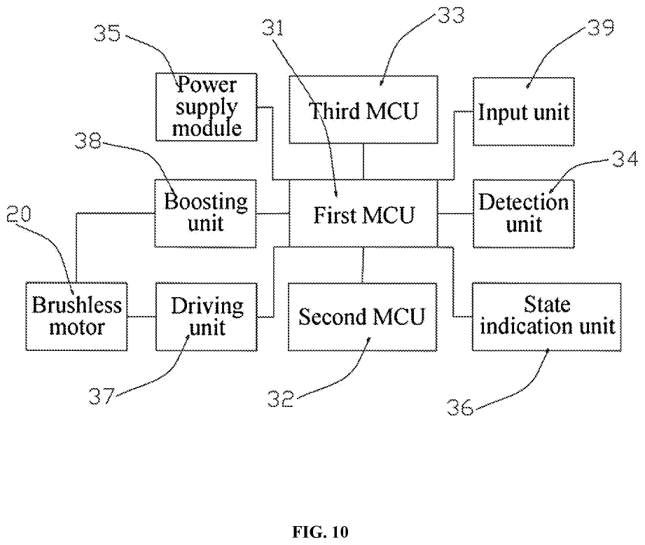

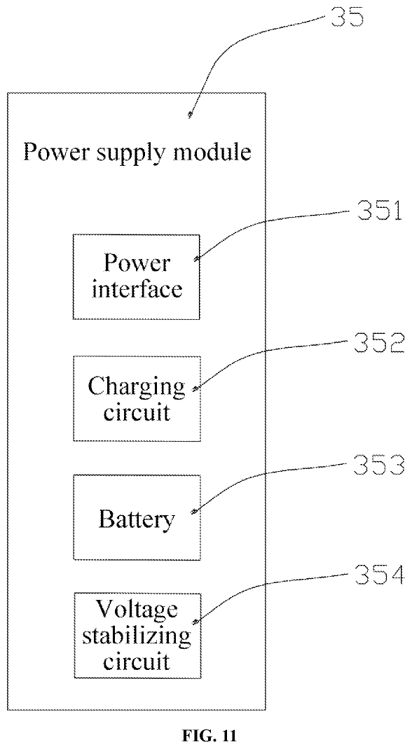

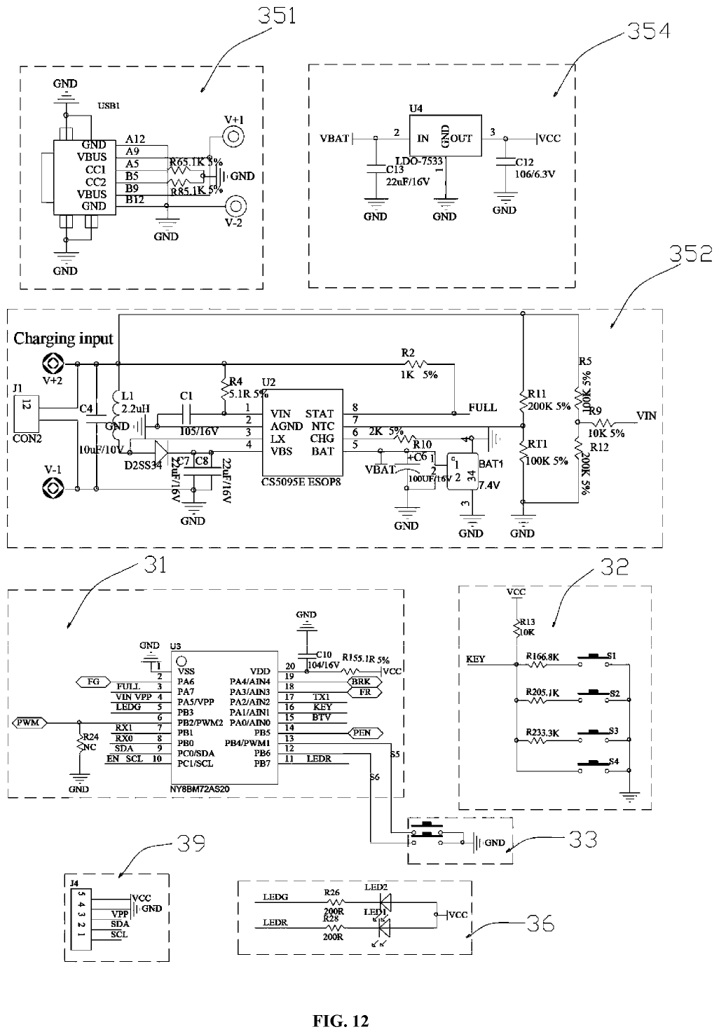

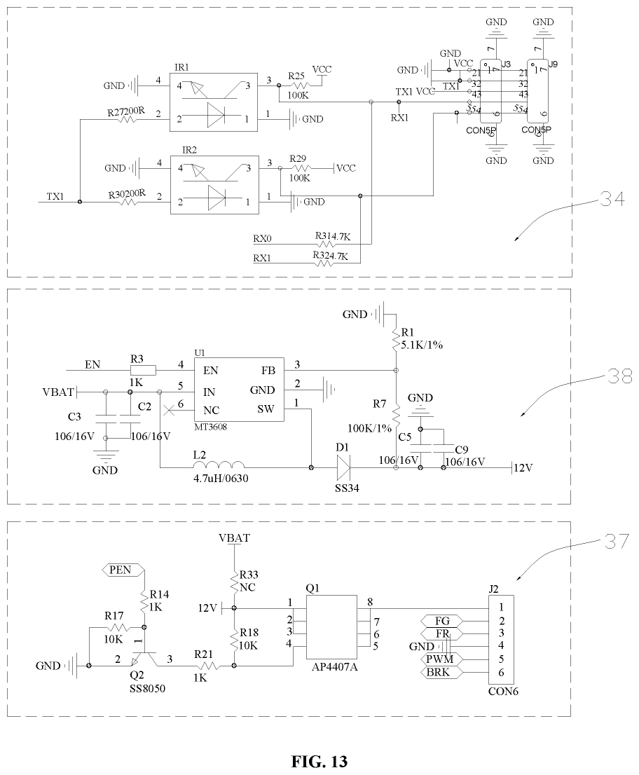

Referring to FIG. 1 to FIG. 13, a male sexual stimulation device includes:
a shell 10, wherein the shell 10 is provided with a first accommodating chamber 11;
a brushless motor 20, wherein the brushless motor 20 is arranged in the first accommodating chamber 11;
a first MCU 31, wherein the first MCU 31 is arranged in the first accommodating chamber 11 and is electrically connected to the brushless motor 20; the first MCU 31 controls a rotating speed of the brushless motor 20 and/or an initial position and final position of the brushless motor 20;
a screw rod 40, wherein the screw rod 40 is connected to an output end of the brushless motor 20 and rotates in a reciprocating manner under the driving of the brushless motor 20;
a sliding block 50, wherein the sliding block 50 is in threaded connection to the screw rod 40 and does a reciprocating motion under the driving of the screw rod 40; and
a connector 60, wherein the connector 60 is connected to the sliding block 50 and moves in a reciprocating manner with the sliding block 50; and the connector 60 is configured to connect a flexible sleeve.

By the arrangement of the above structure, during use, the first MCU 31 controls the brushless motor 20 to do the reciprocating motion, and the screw rod 40 rotates in the reciprocating manner with the brushless motor 20. The sliding block 50 is in threaded connection to the screw rod 40. When the screw rod 40 rotates in the reciprocating manner, the sliding block 50 is driven to do a linear reciprocating motion, thereby driving the connector 60 and the flexible sleeve 101 connected to the connector 60, which can rub and stimulate a male genital organ put into the flexible sleeve 101 and provide a user with sexual stimulation. It is convenient to use. Meanwhile, the user can also control the rotating speed of the brushless motor 20 and/or the initial position and final position of the brushless motor 20 through the first MCU 31, thereby controlling speeds and strokes of the reciprocating motions of both the connector 60 and the flexible sleeve 101 connected to the connector 60, so that the user can freely adjust the product according to own needs, and the applicability of the product is improved. The first MCU is integrated on a circuit board 30. The circuit board 30 is arranged in the first accommodating chamber 11. Preferably, the first MCU is a singlechip microcomputer NY8BM72AS20.

In this embodiment, the male sexual stimulation device further includes a sliding rod 70; the sliding rod 70 is substantially parallel to the screw rod 40, and the sliding block 50 is provided with a sliding hole 51; the sliding rod 70 is inserted along the sliding hole 51; and when the sliding block 50 is in reciprocating motion driven by the screw rod 40, the sliding hole 51 slides in a reciprocating manner along a surface of the sliding rod 70. By the arrangement of the above structure, the sliding rod 70 is inserted into the sliding hole 51, and the sliding hole 51 slides in the reciprocating manner along the surface of the sliding rod 70, which can limit the motion of the sliding block 50 in a circumferential direction of the screw rod. When the screw rod 40 rotates, the sliding block 50 better moves in the reciprocating manner along the surface of the screw rod, which improves the stability of the product.

In this embodiment, the male sexual stimulation device further includes two handles 80; the two handles 80 protrude out along two sides of the shell 10; and the handles 80 are provided for being held by a user. By the arrangement of the above structure, the two handles 80 are arranged on the two sides of the shell 10. During use, the user can hold the handles with both hands, facilitating the use. Meanwhile, the connector 60 and the flexible sleeve 101 connected to the connector 60 can also be prevented from colliding with the hands of the user during the reciprocating motion, so that harms to the user are prevented, and the user experience is better.

In this embodiment, the male sexual stimulation device further includes adjustment buttons 91 and a second MCU 32; the handles 80 are provided with a second accommodating chamber 81 and button holes 82 that passes through surfaces of the handles 80 and are communicated to the second accommodating chamber 81; the second MCU 32 is arranged in the second accommodating chamber 81; the adjustment buttons 91 are connected to the second MCU 32 and protrude out along the button holes 82; the second MCU 32 is electrically connected to the first MCU 31; the second MCU 32 generates a first electrical signal in response to a user operation; and the first MCU 31 receives the first electrical signal and controls the rotating speed of the brushless motor 20 and/or the initial position and final position of the brushless motor 20 according to the first electrical signal. By the arrangement of the above structure, during use, the user can hold the handles 80 and press the adjustment buttons 91 to trigger the second MCU 32 to generate the first electrical signal. Then, the rotating speed of the brushless motor 20 and/or the initial position and final position of the brushless motor 20 can be adjusted through the first MCU 3, so that it is convenient for the user to adjust the motion speeds of both the connector 60 and the flexible sleeve 101 connected to the connector 60, and/or the initial position and final position of the flexible sleeve 101 and to perform an adjustment operation. Preferably, the adjustment buttons 91 are arranged on at positions, close to the fingers of the user, on the surfaces of the handles 80, generally on upper or front surfaces of the handles, to facilitate the user to press the adjustment buttons 91.

In this embodiment, the male sexual stimulation device further includes an ON/OFF button 92 and a third MCU 33; the third MCU 33 is arranged in the second accommodating chamber 81; the ON/OFF button 92 is connected to the third MCU 33 and protrudes out along the button holes 82; the third MCU 33 is electrically connected to the first MCU 31; the third MCU 33 generates a second electrical signal in response to a user operation; and the first MCU 31 receives the second electrical signal and controls, according to the second electrical signal, the brushless motor 20 to be turned on or turned off. By the arrangement of the above structure, the user presses the ON/OFF button 92 and triggers the third MCU 33 to generate the second electrical signal. Then, the first MCU 31 can control the brushless motor 20 to be turned on or turned off according to the second electrical signal, so that the user can freely turn on or turn off the product, which facilitates the use.

In this embodiment, the male sexual stimulation device further includes a detection unit 34; the detection unit 34 is electrically connected to the first MCU 31; the detection unit 34 detects a position of the sliding block 50 and generates a third electrical signal; and the first MCU 31 receives the third electrical signal and controls, according to the third electrical signal, the brushless motor 20 to adjust the initial position and final position of the reciprocating motion. By the arrangement of the above structure, the detection unit 34 can detect the position of the sliding block 50, thereby generating the third electrical signal. The first MCU 31 controls the brushless motor 20 according to the third electrical signal, which effectively monitors a motion speed and motion progress of the sliding block 50 and prevents jamming or loss of control. This can greatly improve the safety of the product and facilitate the use. Preferably, the detection unit 34 is an infrared detection unit.

In this embodiment, the male sexual stimulation device further includes a power supply module 35; the power supply module 35 is electrically connected to the first MCU 31 and is electrically connected to the second MCU 32, the third MCU 33, and the brushless motor 20 through the first MCU 31. By the arrangement of the above structure, with the power supply module 35, the product can be used without mains supply, so that limitations on usage scenarios are reduced, the product is more convenient to carry, and the battery life of the product is effectively prolonged.

In this embodiment, the power supply module 35 includes a power interface 351, a charging circuit 352, a battery 353, and a voltage stabilizing circuit 354; the charging circuit 352 is electrically connected to the power interface 351 and the battery 353; and the voltage stabilizing circuit 354 is electrically connected to the battery 353 and the first MCU 31. By the arrangement of the above structure, during use, the power interface 351 is externally connected to a power supply terminal such as the mains supply, and a voltage and current are adjusted through the charging circuit 352; and electric energy is stored in the battery. The voltage stabilizing circuit 354 can effectively adjust an output voltage, making the product safer to use. The charging circuit 352 is a charging chip CS5095E ESOP8.

In this embodiment, the male sexual stimulation device further includes a state indication unit 36; and the state indication unit 36 is electrically connected to the first MCU 31. By the arrangement of the above structure, during use, the first MCU 31 outputs a state signal according to a working state of the brushless motor 20, and the state indication unit 36 outputs information such as light and sound according to the state signal, so that it is convenient for the user to timely understand an operating state of the product and achieve human-computer interactions. Preferably, the state indication unit 36 can be an indicator lamp, a buzzer, and the like.

In this embodiment, the connector 60 includes a connecting rod 61 and a connecting block 62; a surface of the shell 10 is provided with a sliding chute 12; an extension direction of the sliding chute 12 is matched with a direction of the screw rod 40; one end of the connecting rod 61 is connected to the sliding block 50; and the other end of the connecting rod 61 protrudes out of the sliding chute 12 and is connected to the connecting block 62. By the arrangement of the above structure, during use, the screw rod 40 rotates in the reciprocating manner under the driving of the brushless motor 20, thereby driving the sliding block 50 to slide in the reciprocating manner along a surface of the screw rod 40. The connecting rod 61 slides in a reciprocating manner in the sliding chute 12 with the sliding block 50, thereby driving the connecting block 62. The user can connect different flexible sleeves 101 through the connecting block 62, so that different use experiences can be provided for the user.

In this embodiment, the male sexual stimulation device further includes a driving unit 37. The driving unit 37 is electrically connected to the first MCU 31 and the brushless motor 20; the first MCU 31 controls the rotating speed of the brushless motor 20 and/or the initial position and final position of the brushless motor 20 through the driving unit 37. By the arrangement of the above structure, the first MCU 31 generates a control signal, and the driving unit 37 adjusts the rotating speed and/or the initial position and final position of the brushless motor according to the control signal, which can stably adjust the brushless motor 20 and facilitate the use. Preferably, the driving unit 37 is a chip AP4407A.

In this embodiment, the male sexual stimulation device further includes a boosting unit 38. An input end of the boosting unit 38 is electrically connected to the first MCU 31, and an output end of the boosting unit 38 is electrically connected to the brushless motor 20. By the arrangement of the above structure, during use, the boosting unit 38 can convert the electrical energy output by the first MCU 31 into higher-voltage electrical energy, thereby driving the brushless motor 20 to move, which facilitates the use. The boosting unit 38 is a boosting circuit MT3608.

In this embodiment, the male sexual stimulation device further includes an input unit 39. An output end of the input unit 39 is electrically connected to the first MCU 31, and the input unit 39 is configured to input and/or output information. By the arrangement of the above structure, the user can input a preset motion mode of the brushless motor 20 through the input unit 39. In a use process, the user can press a mode adjustment button to generate a mode adjustment signal. Then, the first MCU 31 controls, on the basis of the mode adjustment signal, the brushless motor 20 to work according to the preset motion mode. This provides the user with more different types of use experiences and facilitates the adjustment.

Referring to FIG. 1 to FIG. 13, a male sexual stimulation device includes:
a shell 10, wherein the shell 10 is provided with a first accommodating chamber 11;
a brushless motor 20, wherein the brushless motor 20 is arranged in the first accommodating chamber 11;
a first MCU 31, wherein the first MCU 31 is arranged in the first accommodating chamber 11 and is electrically connected to the brushless motor 20; the first MCU 31 controls a rotating speed of the brushless motor 20 and/or an initial position and final position of the brushless motor 20;
a screw rod 40, wherein the screw rod 40 is connected to an output end of the brushless motor 20 and rotates in a reciprocating manner under the driving of the brushless motor 20;
a sliding block 50, wherein the sliding block 50 is in threaded connection to the screw rod 40 and does a reciprocating motion under the driving of the screw rod 40;
a connector 60, wherein the connector 60 is connected to the sliding block 50 and moves in a reciprocating manner with the sliding block 50; and
a flexible sleeve 101, wherein the flexible sleeve 101 is connected to the connector 60.

By the arrangement of the above structure, during use, the first MCU 31 controls the brushless motor 20 to do the reciprocating motion, and the screw rod 40 rotates in the reciprocating manner with the brushless motor 20. The sliding block 50 is in threaded connection to the screw rod 40. When the screw rod 40 rotates in the reciprocating manner, the sliding block 50 is driven to do a linear reciprocating motion, thereby driving the connector 60 and the flexible sleeve 101 connected to the connector 60, which can rub and stimulate a male genital organ put into the flexible sleeve 101 and provide a user with sexual stimulation. It is convenient to use. Meanwhile, the user can also control the rotating speed of the brushless motor 20 and/or the initial position and final position of the brushless motor 20 through the first MCU 31, thereby controlling speeds and strokes of the reciprocating motions of both the connector 60 and the flexible sleeve 101 connected to the connector 60, so that the user can freely adjust the product according to own needs, and the applicability of the product is improved. The first MCU is integrated on a circuit board 30. The circuit board 30 is arranged in the first accommodating chamber 11. Preferably, the first MCU is a singlechip microcomputer NY8BM72AS20.

In this embodiment, the male sexual stimulation device further includes a sliding rod 70; the sliding rod 70 is substantially parallel to the screw rod 40, and the sliding block 50 is provided with a sliding hole 51; the sliding rod 70 is inserted along the sliding hole 51; and when the screw rod 40 is driven to move in the reciprocating manner, the sliding hole 51 slides in a reciprocating manner along a surface of the sliding rod 70. By the arrangement of the above structure, the sliding rod 70 is inserted into the sliding hole 51, and the sliding hole 51 slides in the reciprocating manner along the surface of the sliding rod 70, which can limit the motion of the sliding block 50 in a circumferential direction of the screw rod. When the screw rod 40 rotates, the sliding block 50 better moves in the reciprocating manner along the surface of the screw rod, which improves the stability of the product.

In this embodiment, the male sexual stimulation device further includes two handles 80; the two handles 80 protrude out along two sides of the shell 10; and the handles 80 are provided for being held by a user. By the arrangement of the above structure, the two handles 80 are arranged on the two sides of the shell 10. During use, the user can hold the handles with both hands, facilitating the use. Meanwhile, the connector 60 and the flexible sleeve 101 connected to the connector 60 can also be prevented from colliding with the hands of the user during the reciprocating motion, so that harms to the user are prevented, and the user experience is better.

In this embodiment, the male sexual stimulation device further includes adjustment buttons 91 and a second MCU 32; the handles 80 are provided with a second accommodating chamber 81 and button holes 82 that passes through surfaces of the handles 80 and are communicated to the second accommodating chamber 81; the second MCU 32 is arranged in the second accommodating chamber 81; the adjustment buttons 91 are connected to the second MCU 32 and protrude out along the button holes 82; the second MCU 32 is electrically connected to the first MCU 31; the second MCU 32 generates a first electrical signal in response to a user operation; and the first MCU 31 receives the first electrical signal and controls the rotating speed of the brushless motor 20 and/or the initial position and final position of the brushless motor 20 according to the first electrical signal. By the arrangement of the above structure, during use, the user can hold the handles 80 and press the adjustment buttons 91 to trigger the second MCU 32 to generate the first electrical signal. Then, the rotating speed of the brushless motor 20 and/or the initial position and final position of the brushless motor 20 can be adjusted through the first MCU 3, so that it is convenient for the user to adjust the motion speeds of both the connector 60 and the flexible sleeve 101 connected to the connector 60, and/or the initial position and final position of the flexible sleeve 101 and to perform an adjustment operation. Preferably, the adjustment buttons 91 are arranged on at positions, close to the fingers of the user, on the surfaces of the handles 80, generally on upper or front surfaces of the handles, to facilitate the user to press the adjustment buttons 91.

In this embodiment, the male sexual stimulation device further includes an ON/OFF button 92 and a third MCU 33; the third MCU 33 is arranged in the second accommodating chamber 81; the ON/OFF button 92 is connected to the third MCU 33 and protrudes out along the button holes 82; the third MCU 33 is electrically connected to the first MCU 31; the third MCU 33 generates a second electrical signal in response to a user operation; and the first MCU 31 receives the second electrical signal and controls, according to the second electrical signal, the brushless motor 20 to be turned on or turned off. By the arrangement of the above structure, the user presses the ON/OFF button 92 and triggers the third MCU 33 to generate the second electrical signal. Then, the first MCU 31 can control the brushless motor 20 to be turned on or turned off according to the second electrical signal, so that the user can freely turn on or turn off the product, which facilitates the use.

In this embodiment, the male sexual stimulation device further includes a detection unit 34; the detection unit 34 is electrically connected to the first MCU 31; the detection unit 34 detects a position of the sliding block 50 and generates a third electrical signal; and the first MCU 31 receives the third electrical signal and controls, according to the third electrical signal, the brushless motor 20 to adjust the initial position and final position of the reciprocating motion. By the arrangement of the above structure, the detection unit 34 can detect the position of the sliding block 50, thereby generating the third electrical signal. The first MCU 31 controls the brushless motor 20 according to the third electrical signal, which effectively monitors a motion speed and motion progress of the sliding block 50 and prevents jamming or loss of control. This can greatly improve the safety of the product and facilitate the use. Preferably, the detection unit 34 is an infrared detection unit.

In this embodiment, the male sexual stimulation device further includes a power supply module 35; the power supply module 35 is electrically connected to the first MCU 31 and is electrically connected to the second MCU 32, the third MCU 33, and the brushless motor 20 through the first MCU 31. By the arrangement of the above structure, with the power supply module 35, the product can be used without mains supply, so that limitations on usage scenarios are reduced, the product is more convenient to carry, and the battery life of the product is effectively prolonged.

In this embodiment, the power supply module 35 includes a power interface 351, a charging circuit 352, a battery 353, and a voltage stabilizing circuit 354; the charging circuit 352 is electrically connected to the power interface 351 and the battery 353; and the voltage stabilizing circuit 354 is electrically connected to the battery 353 and the first MCU 31. By the arrangement of the above structure, during use, the power interface 351 is externally connected to a power supply terminal such as the mains supply, and a voltage and current are adjusted through the charging circuit 352; and electric energy is stored in the battery. The voltage stabilizing circuit 354 can effectively adjust an output voltage, making the product safer to use. The charging circuit 352 is a charging chip CS5095E ESOP8.

In this embodiment, the male sexual stimulation device further includes a state indication unit 36; and the state indication unit 36 is electrically connected to the first MCU 31. By the arrangement of the above structure, during use, the first MCU 31 outputs a state signal according to a working state of the brushless motor 20, and the state indication unit 36 outputs information such as light and sound according to the state signal, so that it is convenient for the user to timely understand an operating state of the product and achieve human-computer interactions. Preferably, the state indication unit 36 can be an indicator lamp, a buzzer, and the like.

In this embodiment, the connector 60 includes a connecting rod 61 and a connecting block 62; a surface of the shell 10 is provided with a sliding chute 12; an extension direction of the sliding chute 12 is matched with a direction of the screw rod 40; one end of the connecting rod 61 is connected to the sliding block 50; and the other end of the connecting rod 61 protrudes out of the sliding chute 12 and is connected to the connecting block 62. By the arrangement of the above structure, during use, the screw rod 40 rotates in the reciprocating manner under the driving of the brushless motor 20, thereby driving the sliding block 50 to slide in the reciprocating manner along a surface of the screw rod 40. The connecting rod 61 slides in a reciprocating manner in the sliding chute 12 with the sliding block 50, thereby driving the connecting block 62. The user can connect different flexible sleeves 101 through the connecting block 62, so that different use experiences can be provided for the user.

In this embodiment, the male sexual stimulation device further includes a driving unit 37. The driving unit 37 is electrically connected to the first MCU 31 and the brushless motor 20; the first MCU 31 controls the rotating speed of the brushless motor 20 and/or the initial position and final position of the brushless motor 20 through the driving unit 37. By the arrangement of the above structure, the first MCU 31 generates a control signal, and the driving unit 37 adjusts the rotating speed and/or the initial position and final position of the brushless motor according to the control signal, which can stably adjust the brushless motor 20 and facilitate the use. Preferably, the driving unit 37 is a chip AP4407A.

In this embodiment, the male sexual stimulation device further includes a boosting unit 38. An input end of the boosting unit 38 is electrically connected to the first MCU 31, and an output end of the boosting unit 38 is electrically connected to the brushless motor 20. By the arrangement of the above structure, during use, the boosting unit 38 can convert the electrical energy output by the first MCU 31 into higher-voltage electrical energy, thereby driving the brushless motor 20 to move, which facilitates the use. The boosting unit 38 is a boosting circuit MT3608.

In this embodiment, the male sexual stimulation device further includes an input unit 39. An output end of the input unit 39 is electrically connected to the first MCU 31, and the input unit 39 is configured to input and/or output information. By the arrangement of the above structure, the user can input a preset motion mode of the brushless motor 20 through the input unit 39. In a use process, the user can press a mode adjustment button to generate a mode adjustment signal. Then, the first MCU 31 controls, on the basis of the mode adjustment signal, the brushless motor 20 to work according to the preset motion mode. This provides the user with more different types of use experiences and facilitates the adjustment.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A male sexual stimulation device, comprising:
a shell, wherein the shell is provided with a first accommodating chamber;
a brushless motor, wherein the brushless motor is arranged in the first accommodating chamber;
a first micro control unit (MCU), wherein the first MCU is arranged in the first accommodating chamber and is electrically connected to the brushless motor; the first MCU controls a rotating speed of the brushless motor and/or an initial position and final position of the brushless motor;
a screw rod, wherein the screw rod is connected to an output end of the brushless motor and rotates in a reciprocating manner under the driving of the brushless motor;
a sliding block, wherein the sliding block is in threaded connection to the screw rod and does a reciprocating motion under the driving of the screw rod; and
a connector, wherein the connector is connected to the sliding block and moves in a reciprocating manner with the sliding block; and the connector is configured to connect a flexible sleeve.

2. The male sexual stimulation device according to claim 1, further comprising a sliding rod, wherein the sliding rod is substantially parallel to the screw rod, and the sliding block is provided with a sliding hole; the sliding rod is inserted along the sliding hole; and when the sliding block is in reciprocating motion driven by the screw rod, the sliding hole slides in a reciprocating manner along a surface of the sliding rod.

3. The male sexual stimulation device according to claim 1, further comprising two handles, wherein the two handles protrude out along two sides of the shell, and the handles are provided for being held by a user.

4. The male sexual stimulation device according to claim 3, further comprising adjustment buttons and a second MCU, wherein the handles are provided with a second accommodating chamber and button holes that passes through surfaces of the handles and are communicated to the second accommodating chamber; the second MCU is arranged in the second accommodating chamber; the adjustment buttons are connected to the second MCU and protrude out along the button holes; the second MCU is electrically connected to the first MCU; the second MCU generates a first electrical signal in response to a user operation; and the first MCU receives the first electrical signal and controls the rotating speed of the brushless motor and/or the initial position and final position of the brushless motor according to the first electrical signal.

5. The male sexual stimulation device according to claim 4, further comprising an ON/OFF button and a third MCU, wherein the third MCU is arranged in the second accommodating chamber; the ON/OFF button is connected to the third MCU and protrudes out along the button holes; the third MCU is electrically connected to the first MCU; the third MCU generates a second electrical signal in response to a user operation; and the first MCU receives the second electrical signal and controls, according to the second electrical signal, the brushless motor to be turned on or turned off.

6. The male sexual stimulation device according to claim 5, further comprising a detection unit, wherein the detection unit is electrically connected to the first MCU; the detection unit detects a position of the sliding block and generates a third electrical signal; and the first MCU receives the third electrical signal and controls, according to the third electrical signal, the brushless motor to adjust the initial position and final position of the reciprocating motion.

7. The male sexual stimulation device according to claim 6, further comprising a power supply module, wherein the power supply module is electrically connected to the first MCU and is electrically connected to the second MCU, the third MCU, and the brushless motor through the first MCU.

8. The male sexual stimulation device according to claim 7, wherein the power supply module comprises a power interface, a charging circuit, a battery, and a voltage stabilizing circuit; the charging circuit is electrically connected to the power interface and the battery; and the voltage stabilizing circuit is electrically connected to the battery and the first MCU.

9. The male sexual stimulation device according to claim 1, further comprising a state indication unit, wherein the state indication unit is electrically connected to the first MCU.

10. The male sexual stimulation device according to claim 1, wherein the connector comprises a connecting rod and a connecting block; a surface of the shell is provided with a sliding chute; an extension direction of the sliding chute is matched with a direction of the screw rod; one end of the connecting rod is connected to the sliding block; and the other end of the connecting rod protrudes out of the sliding chute and is connected to the connecting block.

11. A male sexual stimulation device, comprising:
a shell, wherein the shell is provided with a first accommodating chamber;
a brushless motor, wherein the brushless motor is arranged in the first accommodating chamber;
a first micro control unit (MCU), wherein the first MCU is arranged in the first accommodating chamber and is electrically connected to the brushless motor; the first MCU controls a rotating speed of the brushless motor and/or an initial position and final position of the brushless motor;
a screw rod, wherein the screw rod is connected to an output end of the brushless motor and rotates in a reciprocating manner under the driving of the brushless motor;
a sliding block, wherein the sliding block is in threaded connection to the screw rod and does a reciprocating motion under the driving of the screw rod;
a connector, wherein the connector is connected to the sliding block and moves in a reciprocating manner with the sliding block; and
a flexible sleeve, wherein the flexible sleeve is connected to the connector.

12. The male sexual stimulation device according to claim 11, further comprising a sliding rod, wherein the sliding rod is substantially parallel to the screw rod, and the sliding block is provided with a sliding hole; the sliding rod is inserted along the sliding hole; and when the screw rod is driven to move in the reciprocating manner, the sliding hole slides in a reciprocating manner along a surface of the sliding rod.

13. The male sexual stimulation device according to claim 11, further comprising two handles, wherein the two handles protrude out along two sides of the shell, and the handles are provided for being held by a user.

14. The male sexual stimulation device according to claim 13, further comprising adjustment buttons and a second MCU, wherein the handles are provided with a second accommodating chamber and button holes that passes through surfaces of the handles and are communicated to the second accommodating chamber; the second MCU is arranged in the second accommodating chamber; the adjustment buttons are connected to the second MCU and protrude out along the button holes; the second MCU is electrically connected to the first MCU; the second MCU generates a first electrical signal in response to a user operation; and the first MCU receives the first electrical signal and controls the rotating speed of the brushless motor and/or the initial position and final position of the brushless motor according to the first electrical signal.

15. The male sexual stimulation device according to claim 14, further comprising an ON/OFF button and a third MCU, wherein the third MCU is arranged in the second accommodating chamber; the ON/OFF button is connected to the third MCU and protrudes out along the button holes; the third MCU is electrically connected to the first MCU; the third MCU generates a second electrical signal in response to a user operation; and the first MCU receives the second electrical signal and controls, according to the second electrical signal, the brushless motor to be turned on or turned off.

16. The male sexual stimulation device according to claim 15, further comprising a detection unit, wherein the detection unit is electrically connected to the first MCU; the detection unit detects a position of the sliding block and generates a third electrical signal; and the first MCU receives the third electrical signal and controls, according to the third electrical signal, the brushless motor to adjust the initial position and final position of the reciprocating motion.

17. The male sexual stimulation device according to claim 16, further comprising a power supply module, wherein the power supply module is electrically connected to the first MCU and is electrically connected to the second MCU, the third MCU, and the brushless motor through the first MCU.

18. The male sexual stimulation device according to claim 17, wherein the power supply module comprises a power interface, a charging circuit, a battery, and a voltage stabilizing circuit; the charging circuit is electrically connected to the power interface and the battery; and the voltage stabilizing circuit is electrically connected to the battery and the first MCU.

19. The male sexual stimulation device according to claim 11, further comprising a state indication unit, wherein the state indication unit is electrically connected to the first MCU.

20. The male sexual stimulation device according to claim 11, wherein the connector comprises a connecting rod and a connecting block; a surface of the shell is provided with a sliding chute; an extension direction of the sliding chute is matched with a direction of the screw rod; one end of the connecting rod is connected to the sliding block; and the other end of the connecting rod protrudes out of the sliding chute and is connected to the connecting block.
